(19) United States
(12) Patent Application Publication
(10) Pub. No.: US 2026/0268317 A1
(43) Pub. Date: Sep. 10, 2026

(54) MULTI-USER COLLABORATIVE TRANSACTION MANAGEMENT WITH SHARED INTERFACE

(71) Applicant: Wells Fargo Bank, N.A., San Francisco, CA (US)

(72) Inventors: Alexander Lyudin, New York, NY (US); Alexander Wittkowski, San Francisco, CA (US)

(21) Appl. No.: 19/070,401

(22) Filed: Mar. 4, 2025

(51) Int. Cl. G06Q 20/38; H04L 51/04

(52) U.S. Cl. CPC G06Q 20/386; H04L 51/04

(57) ABSTRACT

Systems and methods are disclosed herein for collaborative transactions using a shared interface. An example method includes receiving a first command to begin a transaction and displaying a user interface (UI) element depicting a modifiable parameter. The example method also includes receiving a second command to begin the collaborative transaction and transmitting the first command and an indication of the UI element to a server. The example method also includes displaying a chat interface and a chat UI element depicting the modifiable parameter and receiving, from the server, an indication that the linked account has modified the chat UI element. The example method also includes displaying an updated chat UI element and receiving a third command to finalize the transaction. The example method also includes updating the modifiable parameter based on the updated chat UI element and transmitting the third command to the server.

### BACKGROUND

User interfaces streamline the experience of conducting online transactions, ensuring that users can easily navigate and select among available options. Effective interfaces provide clear instructions and designs that are responsive to user needs, while ensuring the functionality of the online platform is accessible to the user.

### BRIEF SUMMARY

Online services are typically centered around a relationship where a single user accesses accounts for which they are listed as owner. Many people access online services as part of a household (e.g., families or roommate groups, etc.), and make decisions collaboratively.

Technologies are needed to shift the practice of online services to more closely follow the way customers use these services, such as online shopping, banking, and the like. For example, various embodiments disclosed herein may enable two or more people to share view access for online accounts, transactions, or other pages, thus facilitating the way decisions are made in the real world.

Furthermore, by enabling customers to invite non-customers (e.g., those who may not be familiar with an online service or understand how to use the online interface) to view and/or interact with their information through an online service, such services may be spread to new customers, growing the customer base for the online service. Example embodiments disclosed herein thus pose an opportunity to grow the reach of online services while providing benefits to customers through increased convenience.

Example embodiments disclosed herein transform the traditional online services model (e.g., used in online shopping, financial services, or the like) by embedding a social layer into mobile applications. Such features may encourage customers to interact with family and friends, fostering a collaborative environment that may extend beyond individual-to-individual customer relationships.

Example embodiments may enable customers to invite family members and friends to collaborate in their interactions with online services using a mobile application or other interfaces. Traditionally, such interfaces and interactions are isolated, with each family member managing interactions independently through individual accounts. Example embodiments break down these siloed interactions, creating a more interconnected and supportive ecosystem.

Furthermore, example systems and methods disclosed herein enable an array of social interactions and connections particularly related to online services, such as online transactions. For example, the mobile application may facilitate messaging and group chats that allow users of linked accounts to discuss and approve decisions in real-time, including the use of specialized user interfaces for collaborative decision-making. In another example, a user of a first account may request a linked account to collaborate, and the linked account may approve and modify various parameters of the online interaction. Users may also share or replicate online activities with trusted contacts, promoting a collaborative customer community.

Accordingly, the present disclosure sets forth systems, methods, and apparatuses for collaborative transactions using a shared interface. In an example method, a first device associated with a first account may initiate a transaction with a service provider for a particular transaction or other online service. The first device may issue a command to begin collaborating via the online service by specifying a particular user interface (UI) element and a link to a second linked account. The first device may send a transaction request to a collaborative transaction server, and the transaction request may include details such as the parameter of the transaction to involve in the transaction, identification of a linked account with which to collaborate, and any other details of the online service. The collaborative transaction server may interact with the second device (associated with a second account linked to the first account) to prepare a chat interface between the first account and the second, linked account featuring a chat UI element that mirrors the behavior of the original UI element specified by the first account. The server may then relay any modifications that one account makes to the other account, allowing both accounts to manipulate the chat UI element collaboratively in the chat interface. The first account may then issue a command to finalize the transaction, and the current state of the transaction parameters from the perspective of the first account are sent to the server to use to execute the transaction (or other collaborative online service). The server may then provide a confirmation message to the first device and the second device, indicating the success or failure of the collaborative service.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale.

Some embodiments may include fewer or more components than those shown in the figures.

FIG. 1 illustrates a system in which some example embodiments may be used for X in accordance with some example embodiments described herein.

FIG. 2 illustrates a schematic block diagram of example circuitry embodying a user system for a collaborative transaction system that may perform various operations in accordance with some example embodiments described herein.

FIG. 3 illustrates another schematic block diagram of example circuitry embodying a server system for a collaborative transaction system that may perform various operations in accordance with some example embodiments described herein.

FIG. 4 illustrates an example flowchart for collaborative transactions with shared interfaces, in accordance with some example embodiments described herein.

FIG. 5 illustrates another example flowchart for collaborative transactions with shared interfaces, in accordance with some example embodiments described herein.

FIG. 6 illustrates a swim lane diagram with example operations that may be performed by components of the environment depicted in FIG. 1, in accordance with some example embodiments described herein.

FIG. 7 illustrates another swim lane diagram with example operations that may be performed by components of the environment depicted in FIG. 1, in accordance with some example embodiments described herein.

FIG. 8 illustrates an example user interface used in some example embodiments described herein.

FIG. 9 illustrates another example user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

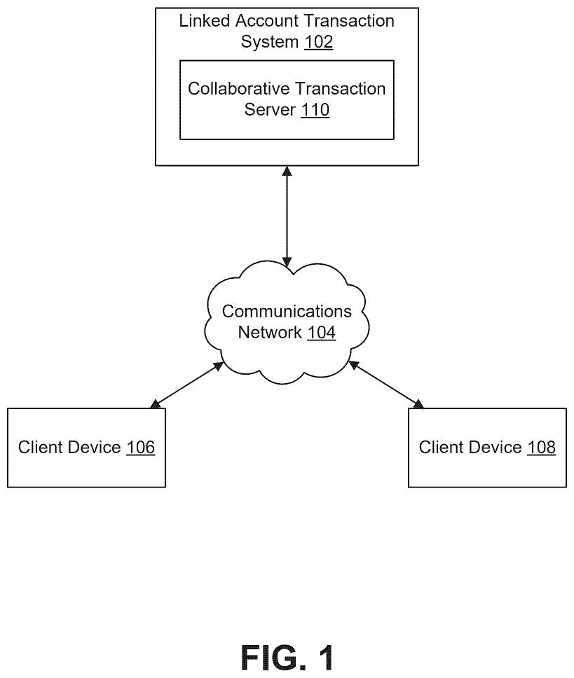

Example embodiments described herein may be implemented using any of a variety of computing devices or servers. To this end, FIG. 1 illustrates an example environment within which various embodiments may operate. As illustrated, a linked account transaction system 102 may receive and/or transmit information via communications network 104 (e.g., the Internet) with any number of other devices, such as client device 106 and/or client device 108, and may additionally include or otherwise interface to a collaborative transaction server 110.

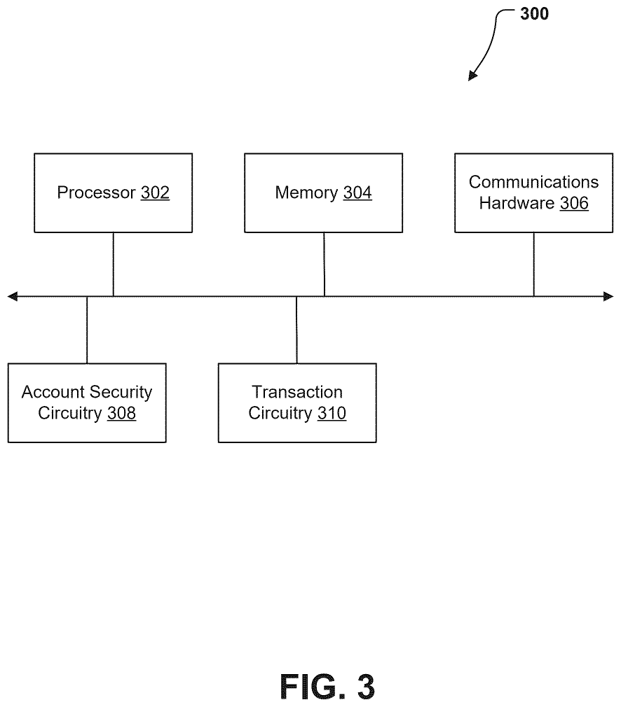

The linked account transaction system 102 (and/or collaborative transaction server 110) may be implemented as one or more computing devices or servers, which may be composed of a series of components. Particular components of the linked account transaction system 102, including components of a collaborative transaction server 110 are described in greater detail below with reference to apparatus 300 in connection with FIG. 3.

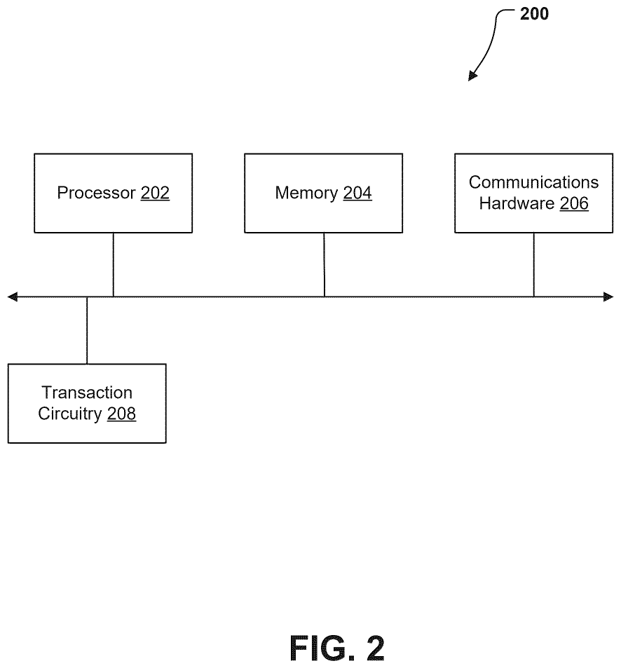

The user device 106 and/or user device 108 may be embodied by any computing devices known in the art. The user device 106-108 need not be an independent device but may be embodied as one or more peripheral devices communicatively coupled to other computing devices. Particular components of the linked client device 106 and/or client device 108 are described in greater detail below with reference to apparatus 200 in connection with FIG. 2.

### Example Implementing Apparatuses

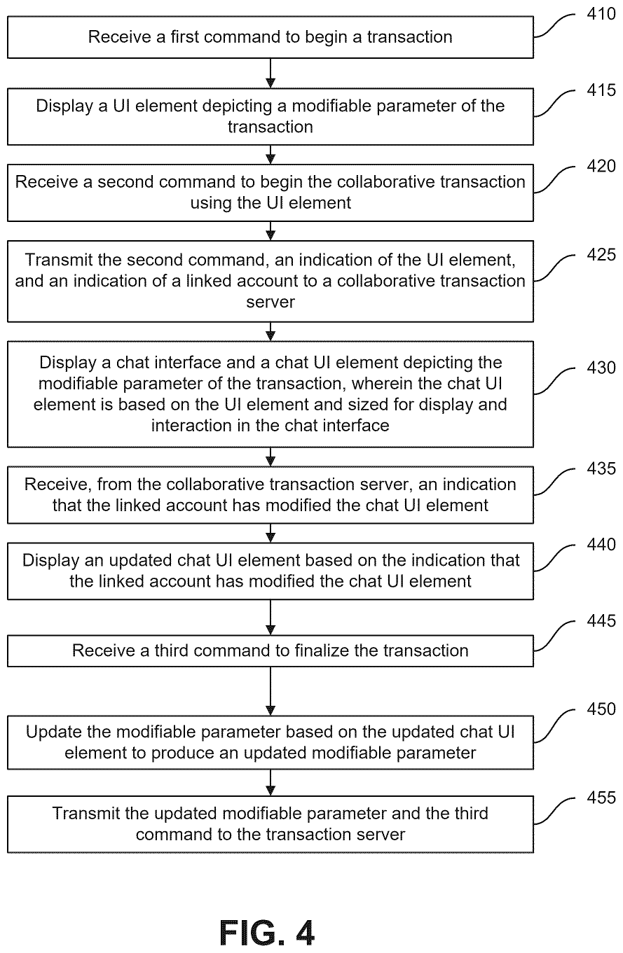

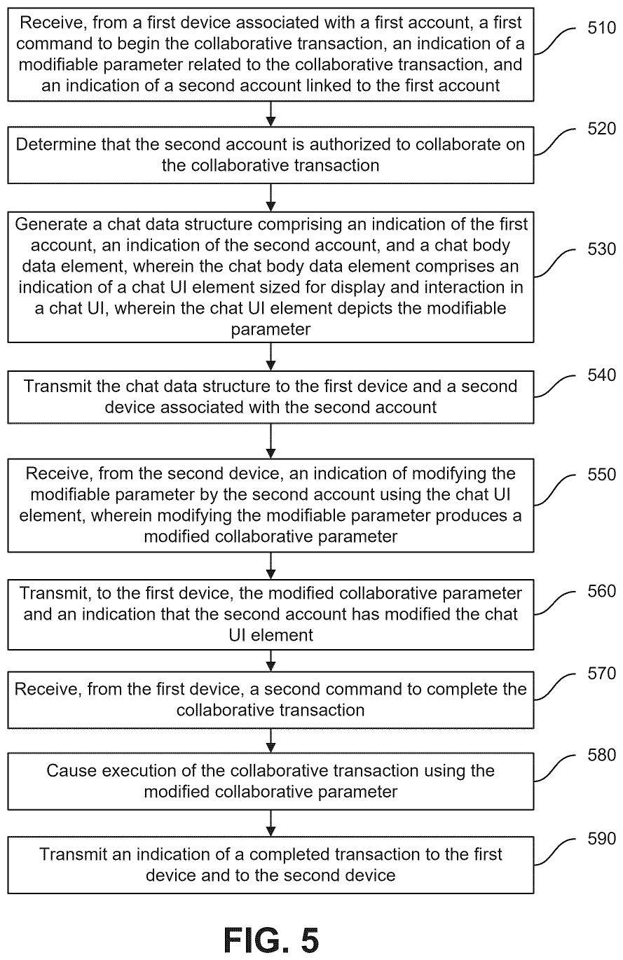

The client device 106 and client device 108 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-5. As illustrated in FIG. 2, the apparatus 200 may include processor 202, memory 204, communications hardware 206, and transaction circuitry 208, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

Additionally, communications hardware 206 may be configured to interpret structured and/or binary data to display various user interfaces (UIs) and receive input from a user via the user interface. For example, the apparatus 200 may be configured to render various UI elements from a common library of UI elements, combine the elements in pre-determined ways. The UI elements may be interacted with by a user to display data and/or receive input data from a user, which may be used to perform the operations described in FIGS. 4-5 below.

In addition, the apparatus 200 further comprises a transaction circuitry 208 that may update modifiable parameters based on user interactions with UI elements. The transaction circuitry 208 may utilize processor 202, memory 204, or any other hardware component included in the apparatus 200 to perform these operations, as described in connection with FIGS. 4-5 below. The transaction circuitry 208 may further utilize communications hardware 206 to gather data from a variety of sources (e.g., linked account transaction system 102, client device 106-108, shown in FIG. 1), and/or exchange data with a user, and in some embodiments may utilize processor 202 and/or memory 204 to modify parameters of a transaction.

Although components 202-208 are described in part using functional language, it will be understood that the particular implementations necessarily include the use of particular hardware. It should also be understood that certain of these components 202-208 may include similar or common hardware. For example, the transaction circuitry 208 may at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. While the term “circuitry” should be understood broadly to include hardware, in some embodiments, the term “circuitry” may in addition refer to software instructions that configure the hardware components of the apparatus 200 to perform the various functions described herein.

Although the transaction circuitry 208 may leverage processor 202, memory 204, or communications hardware 206 as described above, it will be understood that transaction circuitry 208 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that transaction circuitry 208 comprises particular machinery designed for performing the functions described herein in connection with such elements of apparatus 200.

In some embodiments, various components of the apparatuses 200 may be hosted remotely (e.g., by one or more cloud servers) and thus need not physically reside on the apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As illustrated in FIG. 3, an apparatus 300 is shown that represents an example collaborative transaction server 110. The apparatus 300 includes processor 302, memory 304, communications hardware 306, and transaction circuitry 310, each of which is configured to be similar to the similarly named components described above in connection with FIG. 2. In addition, the transaction circuitry 310 may further be configured, in the case of apparatus 300, to generate and cause display of various UI elements based on transaction and/or account data, and to cause execution of transactions based on transaction data.

In addition, the apparatus 300 further comprises an account security circuitry 308 that may determine whether an account is authorized to collaborate on a transaction. The account security circuitry 308 may utilize processor 302, memory 304, or any other hardware component included in the apparatus 300 to perform these operations, as described in connection with FIGS. 4-5 below. The account security circuitry 308 may further utilize communications hardware 306 to gather data from a variety of sources (e.g., client devices 106-108, shown in FIG. 1), and/or exchange data with a user, and in some embodiments may utilize processor 302 and/or memory 304 to evaluate account security and permissions.

In some embodiments, various components of the apparatuses 200 and 300 may be hosted remotely (e.g., by one or more cloud servers) and thus need not physically reside on the apparatus 200 or apparatus 300. For instance, some components of the apparatus 200 or apparatus 300 may not be physically proximate to the other components of apparatus 200 or apparatus 300. Similarly, some or all of the functionality described herein may be provided by third party circuitry. For example, a given apparatus 200 or apparatus 300 may access one or more third party circuitries in place of local circuitries for performing certain functions.

As will be appreciated based on this disclosure, example embodiments contemplated herein may be implemented by an apparatus 200 and/or apparatus 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, and/or apparatus 300 in FIG. 3 that loading the software instructions onto a computing device or apparatus produces a special-purpose machine comprising the means for implementing various functions described herein.

Having described specific components of example apparatuses 200 and 300, example embodiments are described below in connection with a series of graphical user interfaces and flowcharts.

### Example Operations

Turning to FIG. 4, and 5, example flowcharts are illustrated that contain example operations implemented by example embodiments described herein. The operations illustrated in FIGS. 4-5 may, for example, be performed by the linked account transaction system 102, collaborative transaction server 110, client device 106, and/or client device 108, shown in FIG. 1, which may in turn be embodied by an apparatus 200 or apparatus 300, which are shown and described in connection with FIGS. 2-3. To perform the operations described below, the apparatus 200 and/or apparatus 300 may utilize one or more of processor 202, memory 204, communications hardware 206, transaction circuitry 208, processor 302, memory 304, communications hardware 306, account security circuitry 308, transaction circuitry 310, and/or any combination thereof. It will be understood that user interaction with the linked account transaction system 102 or any other systems may occur directly via attached communications hardware or may instead be facilitated by a separate device for user input and output, and which may have similar or equivalent physical componentry facilitating such user interaction.

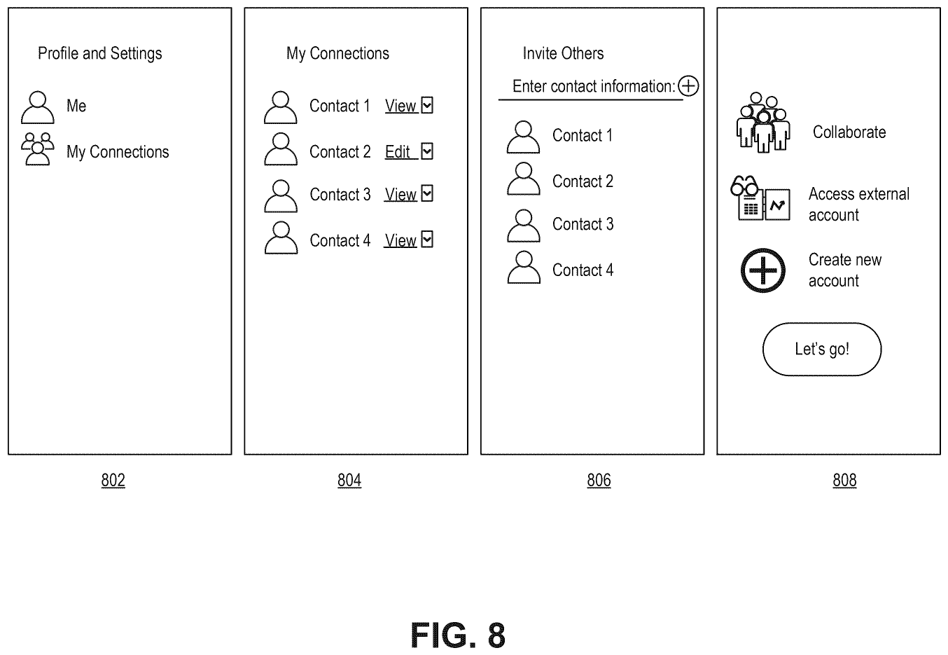

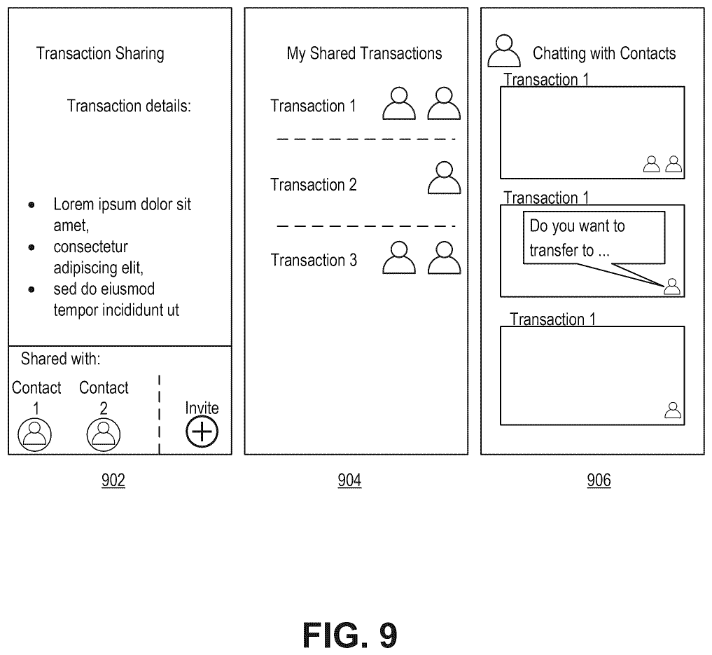

Turning first to FIG. 4, example operations are shown for collaborative transactions with shared interfaces (e.g., using a client device 106). As shown by operation 410, the apparatus 200 includes means, such as communications hardware 206 or the like, for receiving a first command to begin a transaction via a UI. Examples of a UI with which the apparatus 200 may receive the first command are described below, for example, in connection with FIGS. 8-9. In some embodiments, a user may click, touch, or otherwise interact with a UI button that indicates the user's command to begin a transaction or other process. The first command may not necessarily include an indication that the transaction or other process to initiate is collaborative. For example, the transaction may begin without a collaborative property, but the user may decide to make the transaction collaborative after initiating the transaction.

As shown by operation 415, the apparatus 200 includes means, such as communications hardware 206 or the like, for displaying a UI element by the UI depicting a modifiable parameter of the transaction. Examples of a UI with which the apparatus 200 may receive the first command are described below, for example, in connection with FIGS. 8-9. In some embodiments, the transaction may be associated with a variety of configurable properties, including one or more modifiable parameters, each indicated by one or more UI elements. For example, an order for a financial transaction may include a minimum and/or maximum price, a number of shares, a time window for which the transaction order should be valid, names of one or more assets to trade, and/or the like. Accordingly, the communications hardware 206 may display a UI element (e.g., buttons, sliders, text fields, radio buttons, checkboxes, and/or the like) corresponding to the various modifiable parameters or other configurable properties.

The user may interact with any of the UI elements described above to modify any of the modifiable parameters of the transaction or other process (e.g., began at operation 410). In some examples, the apparatus 200 may store (e.g., using memory 204) a local data structure representing the parameters of the transaction or other process. In some examples, the apparatus 200 may communication (via communications hardware 206) with a server (e.g., collaborative transaction server 110 and/or linked account transaction system 102) to provide the parameters of the transaction or other process, which may be saved and validated on the server side. For example, the user may indicate, using an interaction with a UI element, that the currently displayed parameters of the process should be saved and applied, triggering a transfer of the parameter set to the remote server. In some embodiments, the parameter set may automatically be periodically transmitted to backup and/or validate the parameters. This transmission of parameters may occur even in cases in which no collaboration has occurred on the transaction or other process, or a collaboration has not yet been initiated.

As shown by operation 420, the apparatus 200 includes means, such as communications hardware 206 or the like, for receiving a second command by the UI to begin the collaborative transaction using the UI element. The second command may be received using a UI, which may be the same UI described above in connection with operation 410, or a separate UI for initiating collaborative transactions or other collaborative processes. In one example, a UI for a transaction may include a UI element, such as a button, labeled “Add Collaborators,” and interacting with the UI element may cause display of a sub-menu allowing the user to indicate a second user (e.g., a second account, associated with a second device), to add as a collaborator to the active transaction. The sub-menu may further allow the user to specify a UI element relating to a modifiable parameter of the transaction to share with the second user. In another example, the UI may display a “Collaborate” button next to another UI element, where the UI element controls a particular parameter of the transaction. Interacting with the “Collaborate” button may directly indicate that the UI element will be shared and may allow the user to indicate a second user with whom to collaborate. In yet another example, a user may activate a “Collaborate” UI element, which may then prompt the user to provide an indication of a UI element for modifying parameters of the transaction. The user may highlight one or more UI elements, click “Done”, and cause each of the highlighted UI elements to be involved in the collaborative transaction.

In some embodiments, the communications hardware 206 may separately receive an indication of a linked account. The user may provide the indication of the linked account, as in the examples described above, at the time the second command is received, or the linked account may be specified in another way.

As shown by operation 425, the apparatus 200 includes means, such as communications hardware 206 or the like, for transmitting the second command, an indication of the UI element, and an indication of a linked account to a collaborative transaction server 110. As described above, the user may specify a UI element and a linked account when issuing the second command. Issuing the second command may cause a collaborative session with the second account, where control of the specified UI element may be shared. The second command may include further information, which may be retrieved implicitly (without an explicit indication from a user), such as an indication of the transaction or other session (e.g., begun in operation 410).

As shown by operation 430, the apparatus 200 includes means, such as memory 204, communications hardware 206 or the like, for displaying a chat interface and a chat UI element depicting the modifiable parameter of the transaction. The chat UI element may be based on the UI element and sized for display and interaction in the chat interface. In some embodiments, the chat interface and chat UI element may be displayed based on stored data retrieved from memory 204, and in some embodiments, the chat interface and chat UI element may be displayed based on a data structure received via communications hardware 206 (e.g., from the collaborative transaction server 110). In some embodiments, the chat interface may permit the user to engage in a chat session with the user of the linked account, and the UI element may be displayed within or proximate to the chat interface area. In some examples, the chat interface may be an existing chat interface, for example, displaying a chat session that existed prior to the first command and/or the second command. For example, the user may begin a chat with the user of the linked account and subsequently begin the collaborative transaction with the second account. Upon beginning the collaborative transaction, the chat UI element may be added to the existing chat interface as part of the existing chat.

As shown by operation 435, the apparatus 200 includes means, such as communications hardware 206 or the like, for receiving an indication from the collaborative transaction server 110 that the linked account has modified the chat UI element. The collaborative transaction server 110 may (as described below in connection with FIG. 5), cause a second device (e.g., client device 108) to display a chat interface corresponding to the chat interface described above in connection with operation 430. The second device may transmit data indicative of modifying the chat UI element (linked to the modifiable parameter). Accordingly, the collaborative transaction server 110 may relay and/or provide an indication of modifying the chat UI element to the apparatus 200. The collaborative transaction server 110 may, with the indication, also provide other relevant information such as the quantities involved in modifying the chat element, the identity of the linked account, and/or the like.

As shown by operation 440, the apparatus 200 includes means, such as communications hardware 206 or the like, for displaying an updated chat UI element based on the indication that the linked account has modified the chat UI element. The communications hardware 206 may, for example, modify a slider, button, text box, or other control that makes up the chat UI element on the display of the apparatus 200. The communications hardware 206 may perform the modification in real time or nearly simultaneously with receiving the indication that the linked account has modified the chat UI element. For example, a second user associated with the linked account may modify data via a modifiable parameter using the chat UI element, and the new value of the modifiable parameter may be reflected, with minimal delay (e.g., on the order of milliseconds, induced by network communications), on the display of apparatus 200.

As shown by operation 445, the apparatus 200 includes means, such as communications hardware 206 or the like, for receiving a third command to finalize the transaction. As described in connection with operation 410, the user may issue a command via a UI of the communications hardware 206. In some embodiments, the UI may include a button or other interactable element allowing the user to issue the third command and cause the transaction to be finalized. After finalizing, the modifiable parameters may become fixed, and subsequent inputs attempting to modify parameters (including inputs from the linked account) may be rejected.

As shown by operation 450, the apparatus 200 includes means, such as processor 202, memory 204, communications hardware 206, transaction circuitry 208, or the like, for updating the modifiable parameter based on the updated chat UI element to produce an updated modifiable parameter. Upon issuing the third command, the transaction circuitry 208 may collect the parameters from each chat UI element involved in the collaborative transaction. The values indicated by the chat UI elements may be used to update the modifiable parameters of the transaction. As noted previously, in some embodiments, the apparatus 200 may maintain a local copy of the modifiable parameters, which are principally stored on a remote device such as collaborative transaction server 110. In such embodiments, the apparatus 200 may transmit a final indication of the current state of the modifiable parameters of the transaction to the collaborative transaction server 110, which may be checked for consistency.

As shown by operation 455, the apparatus 200 includes means, such as processor 202, memory 204, communications hardware 206, transaction circuitry 208, or the like, for transmitting, by the communication hardware, the updated modifiable parameter and the third command to the collaborative transaction server 110. As indicated above, the updated modifiable parameters and the third command may be transmitted to the collaborative transaction server 110 to finalize the collaborative transaction.

Turning now to FIG. 5, example operations are shown for collaborative transactions with shared interfaces, (e.g., using a collaborative transaction server 110). As shown by operation 510, the apparatus 300 includes means, such as processor 302, memory 304, communications hardware 306, account security circuitry 308, transaction circuitry 310, or the like, for receiving a first command to begin the collaborative transaction from a first device associated with a first account. The apparatus 300 may further receive an indication of a modifiable parameter related to the collaborative transaction and an indication of a second account linked to the first account. The first device associated with the first account may be client device 106, in accordance with the system shown in FIG. 1 and the example implementing apparatus 200 shown in FIG. 2, which may perform operations in accordance with example methods shown in FIG. 4 and described above. The first command may be identified with the command described in connection with operation 425 above (where the linked account may be identified with the second account, associated with the second device, or client device 108).

As shown by operation 520, the apparatus 300 includes means, such as processor 302, memory 304, account security circuitry 308, or the like, for determining that the second account is authorized to collaborate on the collaborative transaction. The account security circuitry 308 may retrieve information regarding the identity of the second account from memory 304 or other storage. In some embodiments, the memory 304 may store a secure database that includes account information, including information about permissions for linked accounts. For example, the account security circuitry 308 may consult the database of linked account information keyed to an identifier of the first account and verify whether an identifier of the second account is listed as a linked account. In some embodiments, the account security circuitry 308 may retrieve granular details of the account linkage, including information on which operations are permitted to be performed by the linked account. The account linkage may additionally or alternatively be indicated using group membership, such as a case in which the first account and the second account are both members of an account linkage group (which may, for example, include additional accounts that also share linkage properties).

As shown by operation 530, the apparatus 300 includes means, such as processor 302, memory 304, transaction circuitry 310, or the like, for generating a chat data structure comprising an indication of the first account, an indication of the second account, and a chat body data element. The chat body data element may include an indication of a chat UI element sized for display and interaction in a chat UI. The chat UI element may also depict the modifiable parameter. For example, the transaction circuitry 310 may receive the indication of each account involved in the collaborative transaction and the indication of the modifiable parameter. The transaction circuitry 310 may then generate the chat data structure or may first check if a chat data structure already exists (e.g., if the first account and the second account already have an ongoing chat session). Upon generating or retrieving the chat data structure, the transaction circuitry 310 may add or insert an indication of the chat UI element. For example, inserting the indication of the chat UI element may cause an interactable UI element to appear inline with a chat window, and if previous text is available from the chat data structure, the UI element may appear alongside the existing chat text. The chat UI element may be retrieved, for example, from a library of UI elements corresponding to the available modifiable parameters. In some cases, the chat UI element may be the same as the UI element (described in connection with operation 415) displayed in a non-collaborative session, and in other cases, the chat UI element may differ in size, type of interactable element, or other properties in order to make the chat UI element suitable for viewing and use within the chat window context.

As shown by operation 540, the apparatus 300 includes means, such as communications hardware 306 or the like, for transmitting the chat data structure to the first device and a second device associated with the second account. As indicated previously, the communications hardware 306 may transmit to a client device 106 and a client device 108, which may correspond respectively to the first device and second device described here.

As shown by operation 550, the apparatus 300 includes means, such as communications hardware 306 or the like, for receiving, from the second device, an indication of modifying the modifiable parameter by the second account using the chat UI element. In some embodiments, modifying the modifiable parameter may produce a modified collaborative parameter (e.g., the modifiable parameter may be referred to herein as the modified collaborative parameter after modification). As described in connection with operation 435, client device 106 and/or client device 108 may receive a command to modify the modifiable parameter via the chat UI element linked to the modifiable parameter. For example, a user may drag a slider, enter text into a text box, and/or manipulate the chat UI element in other ways. By manipulating the chat UI element, the first or second device may modify underlying data representing a local copy of modifiable parameters of the collaborative transaction. The first or second device may then transmit the indication of modifying the modifiable parameter to the apparatus 300, which may be received and processed by communications hardware 306.

The apparatus 300 may record the modified collaborative parameter to a local copy of the transaction parameters (e.g., using memory 304). In some embodiments, the memory 304 may store a record of all changes to the modifiable parameters, so that previous states of the parameters may be restored at a later time, and/or for resolving conflicts related to concurrent modifications of parameters by multiple devices. Accordingly, in some embodiments, the apparatus 300 may maintain an up-to-date copy of the transaction parameters based on the modifications caused by each party of the collaborative transaction.

As shown by operation 560, the apparatus 300 includes means, such as communications hardware 306 or the like, for transmitting, to the first device, the modified collaborative parameter and an indication that the second account has modified the chat UI element. Upon receiving the indication that a device has modified a modifiable parameter, the communications hardware 306 may (in combination with storing the modified collaborative parameter in memory 304) transmit the modified collaborative parameter (and/or an indication of the parameter being modified) to each device associated with an account connected to the collaborative transaction. In this way, the apparatus 300 may synchronize the state of the modifiable parameters among each participant in the collaborative transaction.

As shown by operation 570, the apparatus 300 includes means, such as communications hardware 306 or the like, for receiving, from the first device, a second command to complete the collaborative transaction. The command to complete the collaborative transaction may come from a device associated with the account that initiated the collaborative transaction (e.g., client device 106 in this example). In some embodiments, control over the collaborative transaction may be transferred to a second account, and thus the second account may issue the command to complete the collaborative transaction. In another example, each account involved in the collaborative transaction may issue a separate command to complete the collaborative transaction, and the apparatus 300 may wait until the command is received from each party of the collaborative transaction before proceeding to finalize the transaction (e.g., proceed to operation 580).

As shown by operation 580, the apparatus 300 includes means, such as processor 302, memory 304, communications hardware 306, transaction circuitry 310, or the like, for causing execution of the collaborative transaction using the modified collaborative parameter. In some embodiments, the transaction circuitry 310 may execute the collaborative transaction directly, for example, by modifying a ledger stored in memory 304. In some embodiments, an external device, such as a transaction server or other dedicated provider, may execute the transaction, and the transaction circuitry 310 may then be responsible for causing execution of the transaction by interfacing with an application programming interface (API) or other such interface of the transaction server. For causing the transaction, the transaction circuitry 310 may use the most recent stored set of collaborative parameters for the transaction, ensuring that each device involved in the transaction has a matching set of parameters, including modifiable parameters.

As shown by operation 590, the apparatus 300 includes means, such as communications hardware 306 or the like, for transmitting an indication of a completed transaction to the first device and to the second device (e.g., client device 106 and client device 108). The communications hardware 306 may transmit the indication of completed transaction with additional data, such as a transaction identifier, receipt for record keeping, and/or other related information.

### Example System Interaction

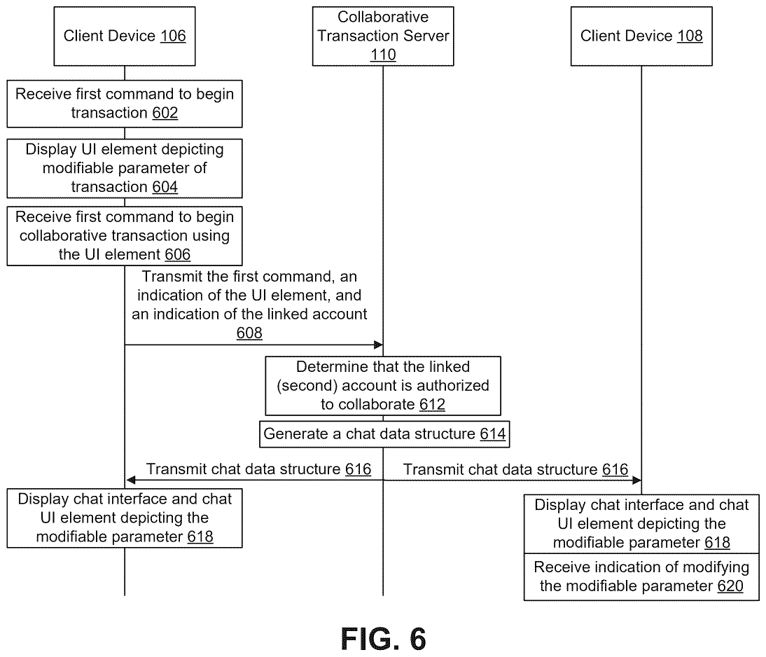

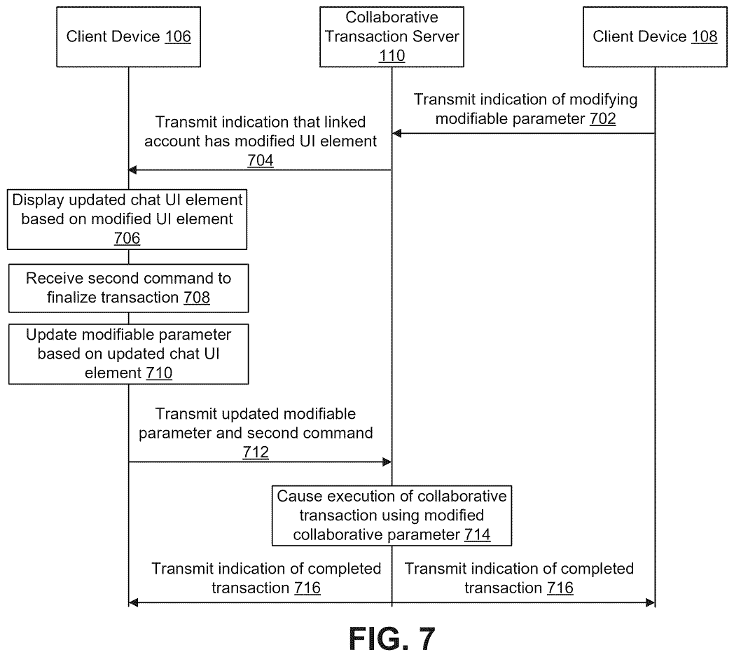

FIGS. 6-7 show swim lane diagrams illustrating example operations (e.g., as described above in connection with FIGS. 4-5) performed by components of the environment depicted in FIG. 1 to produce various benefits of the implementations described herein. The operations shown in the swim lane diagram performed by client device 106 are shown along the line extending from the box labeled “client device 106,” operations performed by a device associated with collaborative transaction server 110 are shown along the line extending from the box labeled “collaborative transaction server 110,” and operations performed by a client device 108 are shown along the line extending from the box labeled “client device 108.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIGS. 6-7.

At operation 602, the client device 106 may receive a first command to begin a transaction or other algorithmic operation. At operation 604, the client device 106 may display a UI element depicting a modifiable parameter of the transaction or other algorithmic operation. At operation 606, the client device 106 may receive a first command to begin a collaborative transaction (or other collaborative operation) using the UI element. At operation 608, the client device 106 may transmit the first command, an indication of the UI element, and an indication of the linked account to the collaborative transaction server 110. At operation 612, the collaborative transaction server 110 may determine that the second account (linked account) is authorized to collaborate with the first account. At operation 614, the collaborative transaction server may generate a chat data structure, and at operation 616, the collaborative transaction server may transmit the chat data structure to client device 106 and client device 108. At operation 618, the client device 106 (and separately, client device 108) may display a chat interface and a chat UI element depicting the modifiable parameter. At operation 620, the client device 108 may receive an indication of modifying the modifiable parameter via the chat UI element.

Turning to FIG. 7, at operation 710, the client device 108 may transmit an indication of modifying the modifiable parameter to collaborative transaction server 110. At operation 704, the collaborative transaction server 110 may transmit an indication that the linked account (second account) has modified the chat UI element (and the modifiable parameter). At operation 706, the client device 106 may display an updated chat UI element based on the modified chat UI element as modified on the client device 108. At operation 708, the client device 106 may receive a second command to finalize the transaction or other algorithmic process. At operation 710, the client device 106 may update a modifiable parameter based on the updated chat UI element. At operation 712, the client device 106 may transmit the updated modifiable parameter and the second command to the collaborative transaction server. At operation 714, the collaborative transaction server 110 may cause execution of the collaborative transaction using the modified collaborative parameter. At operation 716, the collaborative transaction server may transmit an indication of a completed transaction to the client device 106 and client device 108.

In some embodiments, some of the operations described above in connection with FIGS. 4-7 may be modified or further amplified. Furthermore, in some embodiments, additional optional operations may be included. Modifications, amplifications, or additions to the operations above may be performed in any order and in any combination.

Turning to FIGS. 8-9, several examples of a graphical user interface (GUI) are provided that illustrates a mobile application interface for performing a transaction with linked assets. As noted previously, a user may interact with the linked account transaction system 102 by a mobile application of the client device 106 and/or client device 108. In such an embodiment, the GUI shown in FIG. 9 may be displayed to a user by the apparatus 200.

View 802 illustrates a high-level menu for selection options for sharing information with users of other accounts. View 802 includes a “profile and settings” page with options for personal options of the user and settings related to the user's connected accounts.

View 804 illustrates the “my connections” view from “profile and settings” menu shown previously. In this view, a list of contacts (named “contact 1” through “contact 4” for the purposes of this example) are listed, with options to interact with each connection detail including “view” and “edit”.

View 806 illustrates an “invite others” menu in the connections GUI. The view shows existing linked contacts (“contact 1” through “contact 4”) and includes a field for adding new contact information (e.g., an email address, phone number, full name, etc.).

View 908 illustrates a menu of actions that may be taken with respect to a linked account. Options are presented to collaborate with a linked account, access an external account, and create a new account. A button at the bottom of the interface may be used to accept the selected option.

Turning to FIG. 9, view 902 illustrates a view for transaction sharing with a linked account. A field may display a value and/or a short text description of the transaction (transaction details). Additional details, shown in the example as filler text, may provide further context such as notes, description of involved parties, and/or the like. A pane at the bottom of the view shows sharing information and indicates sharing with “contact 1” and “contact 2” by showing profile pictures and contact names. A button labeled “invite” on the right-hand side of the bottom pane may be pressed to add additional contacts to the collaborative view.

View 904 illustrates a “my shared transactions” interface. A list of transactions is shown (in this example, “transaction 1”, “transaction 2”, and “transaction 3”), and each transaction has a compact illustration of the sharing status, which depicts the profile pictures of contacts with whom the transaction is shared.

View 906 illustrates an interface for chatting with contacts. The three chat windows shown correspond go different shared transactions, and a name or other value is indicated in connection with each chat interface. In the corner of each interface is a compact representation of the participants in the chat. An example chat message is shown in the second interface, where participants can suggest transactions using linked accounts.

### Conclusion

As described above, example embodiments provide methods and apparatuses that enable collaborative processes using a shared interface. By opening up online processes that have traditionally been conducted by a single user interfacing with a server through an individual UI, example embodiments improve flexibility and connectedness of user-facing applications.

Traditionally, applications such as those associated with financial institutions or online shopping have operated under the assumption that a single user with a single account interacts directly with the service, but in reality, groups of users often use such services together and share responsibilities. For example, families frequently collaborate on large purchases, travel plans, investments, and other such decisions. By providing an interface for such operations that matches the collaborative reality, example embodiments disclosed herein offer value to the average user that has not been possible with previous approaches.

As these examples all illustrate, example embodiments contemplated herein provide technical solutions that solve real-world problems faced in the field of network security. While past approaches have typically allowed users to directly and individually perform processes through a central server, techniques to involve collaborative aspects at the UI level are still needed. Example embodiments disclosed herein therefore present a shared interface that facilitates collaborative transactions with multiple, mutually trusted accounts, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for a completing a collaborative transaction involving at least a first user device and a second user device in real time, wherein the first user device is remote to the second user device, the method comprising:
receiving, by a user interface (UI) of a communication hardware corresponding to the first user device, a first command to begin a transaction;
displaying, by the UI of the communication hardware corresponding to the first user device, a UI element depicting a transaction state including at least one modifiable parameter of the transaction;
receiving, by the UI of the communication hardware corresponding to the first user device, a second command to begin the collaborative transaction using the UI element;
transmitting, by the communication hardware corresponding to the first user device and to a collaborative transaction server, the first command, an indication of the UI element, and an indication of a linked account corresponding to the second user device;
receiving, by the communication hardware corresponding to the first user device, from the collaborative transaction server, and in response to transmitting the indication of the linked account, an indication that the linked account is authorized to collaborate;
displaying, by the UI of the communication hardware corresponding to the first user device and in response to receiving the indication that the linked account corresponding to the second user device is authorized to collaborate, a chat interface and a chat UI element depicting the transaction state, wherein the chat UI element is based on the UI element and sized for display and interaction in the chat interface, wherein the collaborative transaction server generates a chat data structure including: (i) an indication of the transaction state, (ii) an indication of the linked accounts, and (iii) a representation of the chat UI element, and wherein the chat UI element is linked to the chat data structure and the transaction state maintained by the collaborative transaction server such that modifications to the transaction state are displayed in real-time;
receiving, by the UI of the communication hardware corresponding to the first user device, a third command to finalize the transaction;
updating, by transaction circuitry corresponding to the first user device, the modifiable parameter of the transaction state based on the updated chat UI element to produce an updated transaction state including an updated modifiable parameter; and
transmitting, by the communication hardware corresponding to the first user device, the updated transaction state and the third command to the collaborative transaction server.

2. The method of claim 1, further comprising:
receiving, from the collaborative transaction server, a chat data structure comprising an indication of a first account linked associated with the first command, an indication of the linked account, and a chat body data element, wherein the chat body data element comprises an indication of the chat UI element.

3. The method of claim 1, wherein the first command is associated with a first account, wherein the linked account is a thin account having fewer permissions than the first account.

4. The method of claim 1, further comprising:
upon transmitting the third command, causing execution of the transaction; and
receiving, by the communication hardware and from the collaborative transaction server, confirmation of the execution of the transaction.

5. The method of claim 1, wherein the UI element depicting the modifiable parameter of the transaction comprises an interactable sharing element, wherein interacting with the interactable sharing element causes the chat UI element to be added to the chat interface.

6. The method of claim 1, further comprising:
upon transmitting the second command and before transmitting the third command, receiving, by the UI of the communication hardware, a fourth command to modify the modifiable parameter;
transmitting, by the communication hardware and to the collaborative transaction server, the fourth command; and
modifying the chat UI element based on the fourth command modifying the modifiable parameter.

7. The method of claim 6, wherein the fourth command is received via the chat UI element, the method further comprising:
updating the UI element depicting the modifiable parameter of the transaction based on the fourth command.

8. An apparatus for completing a collaborative transaction involving at least a first user device and a second user device in real time, wherein the first user device is remote to the second user device, the apparatus comprising:
communications hardware corresponding to the first user device, wherein the communications hardware is configured to:
receive, by a user interface (UI) corresponding to the first user device, a first command to begin a transaction,
display, by the UI corresponding to the first user device, a UI element depicting a transaction state including at least one modifiable parameter of the transaction,
receive, by the UI corresponding to the first user device, a second command to begin the collaborative transaction using the UI element,
transmit, to a collaborative transaction server, the first command, an indication of the UI element, and an indication of a linked account corresponding to the second user device,
receive, from the collaborative transaction server and in response to transmitting the indication of the linked account, an indication that the linked account corresponding to the second user device is authorized to collaborate,
display, by the UI and in response to receiving the indication that the linked account corresponding to the second user device is authorized to collaborate, a chat interface and a chat UI element depicting the transaction state, wherein the chat UI element is based on the UI element and sized for display and interaction in the chat interface, wherein the collaborative transaction server generates a chat data structure including: (i) an indication of the transaction state, (ii) an indication of the linked accounts, and (iii) a representation of the chat UI element, and wherein the chat UI element is linked to the chat data structure and the transaction state maintained by the collaborative transaction server such that modifications to the transaction state are displayed in real-time, and
receive, by the UI, a third command to finalize the transaction; and
transaction circuitry corresponding to the first user device, wherein the transaction circuitry is configured to:
update the modifiable parameter of the transaction state based on the updated chat UI element to produce an updated transaction state including an updated modifiable parameter,
wherein the communications hardware is further configured to transmit the updated transaction state and the third command to the collaborative transaction server.

9. The apparatus of claim 8, wherein the communications hardware is further configured to:
receive, from the collaborative transaction server, a chat data structure comprising an indication of a first account associated with the first command, an indication of the linked account, and a chat body data element, wherein the chat body data element comprises an indication of the chat UI element.

10. The apparatus of claim 8, wherein the first command is associated with a first account, wherein the linked account is a thin account having fewer permissions than the first account.

11. The apparatus of claim 8, wherein the communications hardware is further configured to:
upon transmitting the third command, cause execution of the transaction; and
receive, from the collaborative transaction server, confirmation of the execution of the transaction.

12. The apparatus of claim 8, wherein the UI element depicting the modifiable parameter of the transaction comprises an interactable sharing element, wherein interacting with the interactable sharing element causes the chat UI element to be added to the chat interface.

13. The apparatus of claim 8, wherein the communications hardware is further configured to:
upon transmitting the second command and before transmitting the third command, receive, by the UI, a fourth command to modify the modifiable parameter;
transmit, to the collaborative transaction server, the fourth command; and
modify the chat UI element based on the fourth command modifying the modifiable parameter.

14. The apparatus of claim 13, wherein the fourth command is received via the chat UI element, wherein the communications hardware is further configured to:
update the UI element depicting the modifiable parameter of the transaction based on the fourth command.

15. A computer program product for completing a collaborative transaction involving at least a first user device and a second user device in real time, wherein the first user device is remote to the second user device, the computer program product comprising at least one non-transitory computer-readable storage medium storing program instructions that, when executed, cause a system:
receive, by a user interface (UI) corresponding to the first user device, a first command to begin a transaction;
display, by the UI corresponding to the first user device, a UI element depicting a transaction state including at least one modifiable parameter of the transaction;
receive, by the UI corresponding to the first user device, a second command to begin the collaborative transaction using the UI element;
transmit, to a collaborative transaction server, the first command, an indication of the UI element, and an indication of a linked account corresponding to the second user device;
receive, from the collaborative transaction server, and in response to transmitting the indication of the linked account, an indication that the linked account corresponding to the second user device is authorized to collaborate;
display, by the UI corresponding to the first user device and in response to the receiving of the indication that the linked account corresponding to the second user device is authorized to collaborate, a chat interface and a chat UI element depicting the transaction state, wherein the chat UI element is based on the UI element and sized for display and interaction in the chat interface, wherein the collaborative transaction server generates a chat data structure including: (i) an indication of the transaction state, (ii) an indication of the linked accounts, and (iii) a representation of the chat UI element, and wherein the chat UI element is linked to the chat data structure and the transaction state maintained by the collaborative transaction server such that modifications to the transaction state are displayed in real-time;
receive, by the UI corresponding to the first user device, a third command to finalize the transaction;
update the modifiable parameter of the transaction state based on the updated chat UI element to produce an updated transaction state including an updated modifiable parameter; and
transmit the updated transaction state and the third command to the collaborative transaction server.

16. The computer program product of claim 15, further comprising additional program instructions that, when executed, cause the system to:
receive, from the collaborative transaction server, a chat data structure comprising an indication of a first account associated with the first command, an indication of the linked account, and a chat body data element, wherein the chat body data element comprises an indication of the chat UI element.

17. The computer program product of claim 15, wherein the first command is associated with a first account, wherein the linked account is a thin account having fewer permissions than the first account.

18. The computer program product of claim 15, further comprising additional program instructions that, when executed, cause the system to:
upon transmitting the third command, cause execution of the transaction; and
receive, from the collaborative transaction server, confirmation of the execution of the transaction.

19. The computer program product of claim 15, wherein the UI element depicting the modifiable parameter of the transaction comprises an interactable sharing element, wherein interacting with the interactable sharing element causes the chat UI element to be added to the chat interface.

20. The computer program product of claim 15, further comprising additional program instructions that, when executed, cause the system to:
upon transmitting the second command and before transmitting the third command, receive, by the UI, a fourth command to modify the modifiable parameter;
transmit, to the collaborative transaction server, the fourth command; and
modify the chat UI element based on the fourth command modifying the modifiable parameter.
